(19) United States
(12) Patent Application Publication
(10) Pub. No.: US 2006/0194045 A1
(43) Pub. Date: Aug. 31, 2006

(54) Flame-retardant polyester-based fiber for artificial hair

(76) Inventor: Toshiyuki Masuda, Hyogo (JP)

Correspondence Address: BRINKS HOFER GILSON & LIONE, P.O. BOX 10395, CHICAGO, IL, 60610, US

(21) Appl. No.: 10/568,693

(22) PCT Filed: Aug. 16, 2004
(86) PCT No.: PCT/JP04/12039

§ 371 Date: Feb. 17, 2006

(30) Foreign Application Priority Data
Sep. 1, 2003 (JP) 2003-308371

(51) Int. Cl. D02G 3/00; C07F 9/6574

(52) U.S. Cl. 428/364; 524/117

(57) ABSTRACT

A polyester fiber having outstanding flame resistance, curl-setting property, melt-drip-proof property, transparency, devitrification resistance, and controlled gloss of fiber, while maintaining physical properties of usual polyester fibers, such as heat-resistance and tensile elongation and strength is provided. A flame retardant polyester fiber for artificial hair that can solve the problem may be obtained by melt-spinning a composition obtained by melt-kneading 2 to 20 parts by weight of organic cyclic phosphorus compounds and/or phosphoric ester amido compounds (B) into 100 parts by weight of a polyester (A) comprising one or more kinds of polyalkylene terephthalates and copolymerized polyesters having a polyalkylene terephthalate as a principal component, and a composition obtained by blending organic fine particles (C) and/or inorganic fine particles (D) into the above-mentioned composition.

### FIELD OF THE INVENTION

The present invention relates to a fiber for flame retardant polyester artificial hair made of a composition obtained by melt-kneading a specific phosphorus containing flame retardant agent into polyesters. In more detail, the present invention relates to a fiber for artificial hair having outstanding curl-setting and holding property, melt-drip-proof property, transparency, and devitrification resistance, while maintaining physical properties of the fiber, such as flame resistance, heat resistance, and tensile elongation and strength.

### BACKGROUND ART

Since fibers made of polyethylene terephthalate, or polyesters comprising polyethylene terephthalate as a principal component have a high melting point and high modulus of elasticity, and may demonstrate outstanding heat resistance and chemical resistance, they have widely been used for curtains, mattings, clothes, blankets, sheets, tablecloths, fabric upholstery, wall covering materials, artificial hair, and automobile interior finishing materials, outdoor reinforcement, safety nets, etc.

Human hair, artificial hair (modacrylic fiber, polyvinyl chloride fiber), etc. have conventionally been used in hair products, such as wigs, hair wigs, extensions, hair bands, and doll hair. However, human hair is being difficult in availability and therefore importance of artificial hair is now increasing.

Although many modacrylic fibers have been used as artificial hair materials by utilizing flame resistance, it is inadequate in respect of heat resistance. In recent years, artificial hair is proposed that uses fibers having polyesters represented by polyethylene terephthalate with excellent heat resistance as a principal component.

However, since fibers obtained from polyesters represented by polyethylene terephthalate is flammable materials, it has inadequate flame resistance.

Conventionally, various attempts to improve flame resistance of polyester fibers have been performed, and there are known, for example, a method to use fibers made of polyesters copolymerized with flame retardant monomers including phosphorus, and a method to add flame retardant agents in polyester fibers.

As methods of copolymerization with the former flame retardant monomers, for example, there have been proposed a method (Japanese Patent Publication No. 55-41610 official report) of copolymerization with phosphorus compounds, giving satisfactory thermal stability, having phosphorus atom as a ring member; a method of copolymerization with carboxy phosphinic acids (Japanese Patent Publication No. 53-13479 official report); and a method of blending or copolymerization with phosphorus compounds to polyesters comprising polyarylate (Japanese Patent Laid-Open No. 11-124732 official report).

As examples of application to artificial hair of the flame resistance technique, for example, proposed is a polyester fiber obtained by copolymerization of a phosphorus compound. (Japanese Patent Laid-Open No. 3-27105 official report, and Japanese Patent Laid-Open No. 5-339805 official report).

However, since artificial hair needs high flame resistance, use of these copolymerized polyester fibers need a great amount of copolymerization, other problems may occur that the copolymerization greatly reduces heat resistance of the polyester, makes melt spinning difficult, and also may induce melting and dripping although not causing firing and burning, in approach to a flame. In blending of the phosphorus based flame retardant agent, there occur such a problem that an artificial hair comprising an obtained polyester fiber easily gives a problem of visual appearance of the fiber called devitrification, under conditions of exposure to heat or high humidity, in addition to increase in sticky touch resulting from a large quantity of additions needed for expression of flame resistance.

Thus, artificial hairs having excellent curl-setting and retentive property is not yet obtained, while maintaining fiber physical properties, such as flame resistance, heat resistance, strength, elongation, etc. of conventional polyester fibers.

### SUMMARY OF THE INVENTION

As a result of repeated investigation wholeheartedly carried out by the present inventors in order to solve the above-mentioned problems, it was found out that there may be obtained flame retardant polyester fibers for artificial hair having outstanding flame resistance, curl-setting and retentive property, melt-drip-proof property, transparency, and devitrification resistance, while maintaining physical properties of fibers found in usual polyester fibers, such as heat resistance and tensile elongation and strength, by melt-spinning of a composition obtained by melt kneading of organic cyclic phosphorus compounds and/or phosphoric ester amido compounds into polyesters. The organic cyclic phosphorus compounds and/or the phosphoric ester amido compounds found out in the present invention can exhibit sufficient flame resistance and can maintain physical properties of the fiber even with smaller addition as compared with additive type phosphorus based flame retardant agents conventionally used. Furthermore, since a phosphorus based flame retardant agent unit is not introduced into a polymer principal chain as compared with reactive type phosphorus based flame retardant agents, the compounds can maintain heat resistance and melt-drip-proof property of the fiber. In addition, it was also found out that blending of organic fine particles and/or inorganic fine particles into the composition enables control of gloss of the fiber, without causing deterioration of physical properties of the fiber, thus leading to completion of the present invention.

That is, the present invention relates to a flame retardant polyester fiber for artificial hair made of a composition obtained by melt kneading: 100 parts by weight of a polyester (A) comprising one or more kinds selected from polyalkylene terephthalates and copolymerized polyesters having a polyalkylene terephthalate as a principal component and 2 to 20 parts by weight of an organic cyclic phosphorus compound and/or a phosphoric ester amido compound (B), wherein the component (A) preferably is at least one kind of polymers selected from a group consisting of polyethylene terephthalate, polypropylene terephthalate, and poly butylene terephthalate, the component (B) is an organic cyclic phosphorus compound and/or a phosphoric ester amido compound represented by general formulas (1) to (9): 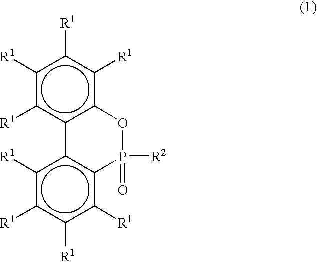
(where, R¹ represents a hydrogen atom, or a linear alkyl group, or an alkyl group having a branch, and each of the R¹ may be identical or different from each other, and R² represents a hydrogen atom, a linear alkyl group, or an alkyl group having a branch, a linear hydroxy alkyl group, or a hydroxy alkyl group having a branch, a cycloalkyl group, a substituted or non-substituted aryl group, or a substituted or non-substituted aralkyl group); 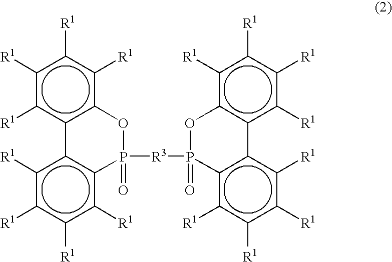
(where, R¹ represents a hydrogen atom, a linear alkyl group, or an alkyl group having a branch, and each of the R¹ may be identical or different from each other, R³ represents a divalent linear alkylene group, or a divalent alkylene group having branch, a linear hydroxy alkyl group, or a hydroxy alkyl group having a branch, a cycloalkylene group, an alkylene group having ether oxygen in a principal chain thereof, a substituted or non-substituted aryl group, a substituted or non-substituted aralkyl group, an α,α′-xylylene group, a substituted-α,α′-xylylene group, an α,α′-meta-xylylene group, or a substituted-α,α′-xylylene group); 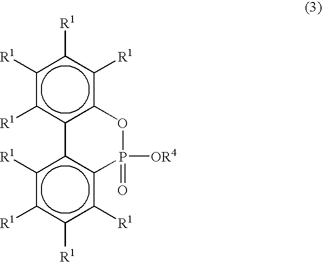
(where, R¹ represents a hydrogen atom, a linear alkyl group, or an alkyl group having a branch, and each of the R¹ may be identical or different from each other, R⁴ represents a hydrogen atom, a linear alkyl group, or an alkyl group having a branch, a cycloalkyl group, a substituted or non-substituted aryl group, or a substituted or non-substituted aralkyl group); 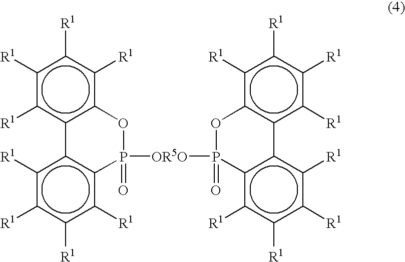
(where, R¹ represents a hydrogen atom, a linear alkyl group, or an alkyl group having a branch, and each of the R¹ may be identical or different from each other, and R⁵ represents a divalent linear alkylene group or a divalent alkylene group having branch, a cycloalkylene group, an alkylene group having ether oxygen in a principal chain thereof, a substituted or non-substituted aryl group, a substituted or non-substituted aralkyl group, an α,α′-xylylene group, a substituted-α,α′-xylylene group, an α,α′-meta-xylylene group, or a substituted-α,α′-xylylene group); 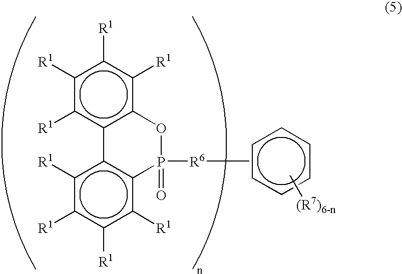
(where, R¹ represents a hydrogen atom, a linear alkyl group, or an alkyl group having a branch, and each of the R¹ may be identical or different from each other, R⁶ represents a divalent linear alkylene group or a divalent alkylene group having branch, a cycloalkylene group, R⁷ represents a hydrogen atom, a linear alkyl group, or an alkyl group having a branch, each of the groups may be identical or different from each other, n represents 1 to 6); 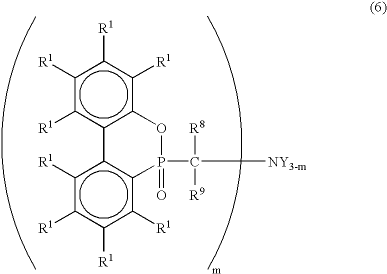
(where, R¹ represents a hydrogen atom, a linear alkyl group, or an alkyl group having a branch, and each of the R¹ may be identical or different from each other, R⁸ and R⁹ represent a hydrogen atom, a linear alkyl group, or an alkyl group having a branch, or a cycloalkyl group, Y represents a hydrogen atom, a linear alkyl group, or an alkyl group having a branch, a cycloalkyl group, a substituted or non-substituted aryl group, or a substituted or non-substituted aralkyl group, each of them may be identical or different from each other, and m represents 1 to 3); 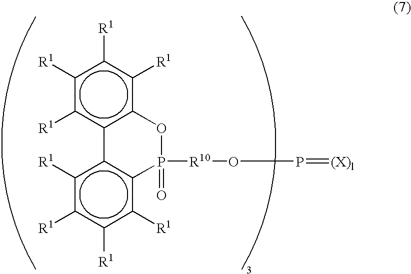
(where, R¹ represents a hydrogen atom, a linear alkyl group, or an alkyl group having a branch, and each of the R¹ may be identical or different from each other, R¹⁰ represents a divalent linear alkylene group or a divalent alkylene group having branch, a linear hydroxy alkyl group, or a hydroxy alkyl group having a branch, a cycloalkylene group, an alkylene group having ether oxygen in a principal chain thereof, a substituted or non-substituted aryl group, or a substituted or non-substituted aralkyl group, X represents oxygen atom or sulfur atom, and 1 represents 0 or 1); 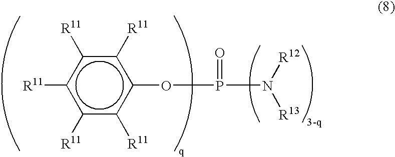
(where, R¹¹ represents a hydrogen atom, a linear alkyl group, or an alkyl group having a branch, and each of the R¹¹ may be identical or different from each other, R¹² and R¹³ represent a hydrogen atom, a linear alkyl group, or an alkyl group having a branch, a linear hydroxy alkyl group, or a hydroxy alkyl group having a branch, a cycloalkyl group, a substituted or non-substituted aryl group, or a substituted or non-substituted aralkyl group, and q represents 1 or 2); 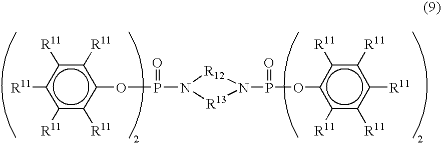
(where, R¹¹ represents a hydrogen atom, a linear alkyl group, or an alkyl group having a branch, and each of the R¹¹ may be identical or different from each other, R¹⁴ and R¹⁵ represent a divalent linear alkylene group or a divalent alkylene group having branch, a linear hydroxy alkyl group, or a hydroxy alkyl group having a branch, a cycloalkylene group, an alkylene group having ether oxygen in a principal chain thereof, a substituted or non-substituted aryl group, or a substituted or non-substituted aralkyl group).

The present invention further relates to the flame retardant polyester fiber for artificial hair, fine projections being formed on a surface of the fiber by blending organic fine particles (C) and/or inorganic fine particles (D) to a composition consisting of component (A) and component (B), wherein the component (C) is at least one kind of material selected from a group consisting of polyarylates, polyamides, fluororesins, silicone resins, cross-linked acrylic resins, and cross-linked polystyrenes, and the component (D) is at least one kind of material selected from a group consisting of calcium carbonate, silicon oxide, titanium oxides, aluminum oxide, zinc oxide, talc, kaolin, montmorillonite, bentonite, and mica. In addition, the flame retardant polyester fiber for artificial hair preferably is of a form of non-crimped fiber, is spun-dyed, and has a single fiber size of 5 to 100 dtex.

### BEST MODE FOR CARRYING-OUT OF THE INVENTION

A flame retardant polyester fiber for artificial hair of the present invention is a melt-spun fiber of a composition obtained by melt-kneading of 100 parts by weight of a polyester (A) comprising one or more kinds selected from polyalkylene terephthalates and copolymerized polyesters having a polyalkylene terephthalate as a principal component, and 2 to 20 parts by weight of an organic cyclic phosphorus compound and/or a phosphoric ester amido compound (B).

As polyalkylene terephthalates or copolymerized polyesters having polyalkylene terephthalate as a principal component included in a polyester (A) used for the present invention, for example, there may be mentioned: polyalkylene terephthalates such as polyethylene terephthalate, polypropylene terephthalate, polybutylene terephthalate, and/or copolymerized polyesters having polyalkylene terephthalate as a principal component, including a small amount of copolymerizable components.

The principal component represents a component having a content of not less than 80 mol %.

The copolymerizable components include, for example: polyvalent carboxylic acids, such as isophthalic acid, ortho-phthalic acid, naphthalene dicarboxylic acid, para-phenylene dicarboxylic acid, trimellitic acid, pyromellitic acid, succinic acid, glutaric acid, adipic acid, suberic acid, azelaic acid, sebacic acid, and dodecanedioic acid, and derivatives of the above-mentioned acids; dicarboxylic acids comprising sulfonate, such as 5-sodium sulfo isophthalate, 5-sodium sulfoisophthalate dihydroxy ethyl, etc., and derivatives of the above-mentioned acids; and 1,2-propanediol, 1,3-propanediol, 1,4-butanediol, 1,6-hexane diol, neopentylglycol, 1,4-cyclohexane dimethanol, diethylene glycol, polyethylene glycol, tri-methylol propane, penta erythritol, 4-hydroxybenzoic acid, ε-caprolactone, etc.

It is preferable, in view of stability and simpler operation, that the copolymerized polyester is usually manufactured by adding a small amount of copolymerizable components into a polymer obtained from terephthalic acid and/or a derivative thereof (for example, methyl terephthalate) as a principal component, and an alkylene glycol, and by reacting them together. Otherwise the copolymerized polyester may also be manufactured by adding a small amount of a monomer or oligomer component as a copolymerizable component into a mixture of terephthalic acid and/or a derivative thereof (for example, methyl terephthalate) as a principal component, and alkylene glycol, and by polymerizing the resulting mixture.

In the copolymerized polyester, the above-mentioned copolymerizable components may just be polycondensed with a principal chain and/or a side-chain of the polyalkylene terephthalate as a principal component, and methods of copolymerization is not especially limited.

Examples of the copolymerized polyester having the polyalkylene terephthalate as a principal component include, for example, polyesters having polyethylene terephthalate as a principal component and obtained by copolymerization with ethylene glycol ether of bisphenol A, with 1,4-cyclohexane dimethanol, or with 5-sodium sulfoisophthalate dihydroxy ethyl etc.

The polyalkylene terephthalate and the copolymerized polyester may be used independently, and they may also be used in combination. In the above-mentioned polyesters, there may be preferably used polyethylene terephthalate, polypropylene terephthalate, polybutylene terephthalate, copolymerized polyesters (polyester having polyethylene terephthalate as a principal component and being obtained by copolymerization with ethylene glycol ether of bisphenol A, with 1,4-cyclohexane dimethanol, or 5-sodium sulfo isophthalate dihydroxy ethyl). These may also preferably be used in combination.

An intrinsic viscosity of the component (A) is preferably 0.5 to 1.4, and more preferably it is 0.6 to 1.2. An intrinsic viscosity less than 0.5 tends to reduce mechanical strength of fibers obtained. Otherwise an intrinsic viscosity exceeding 1.4 tends to cause increase of melt viscosity accompanied by increase of a molecular weight of the fiber, and also results in difficulty in melt-spinning, leading to unevenness size of a fiber.

The organic cyclic phosphorus compound and/or phosphoric ester amido compound (B) used for the present invention has a structure represented by general formulas (1) to (9), and in detail examples of the compound include: compounds represented by general formula (1), 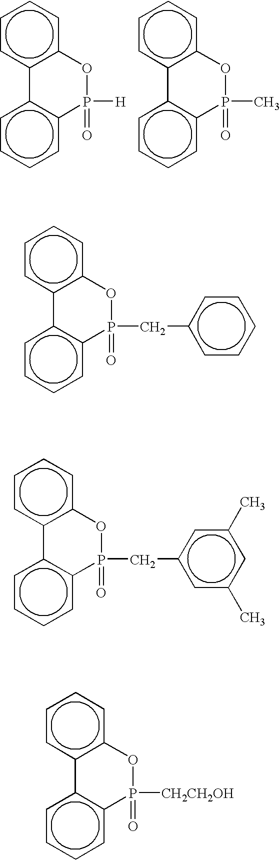
compounds represented by general formula (2), 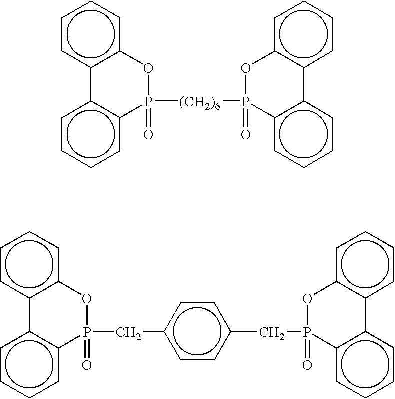
compounds represented by general formula (3), 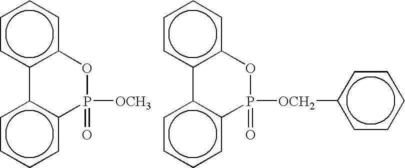
compounds represented by general formula (4), 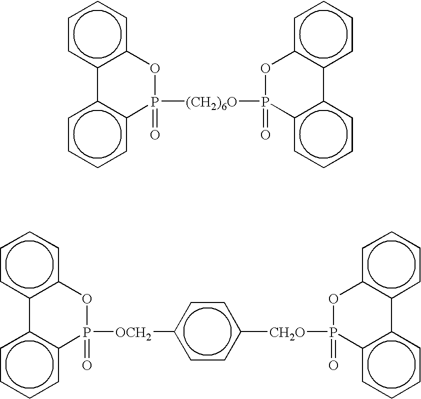
compounds represented by general formula (5), 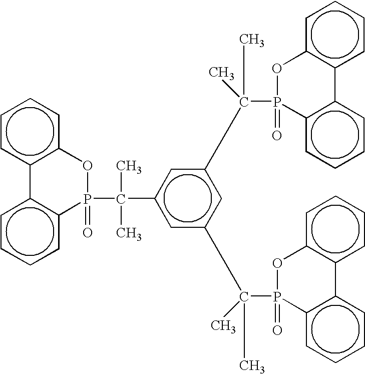
compounds represented by general formula (6), 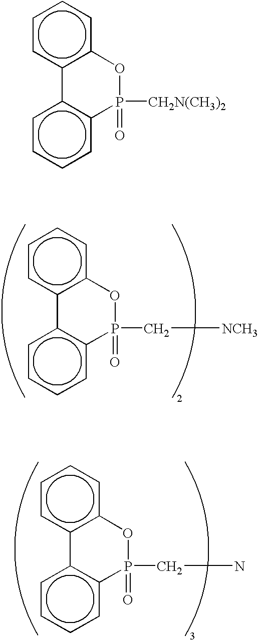
compounds represented by general formula (7), 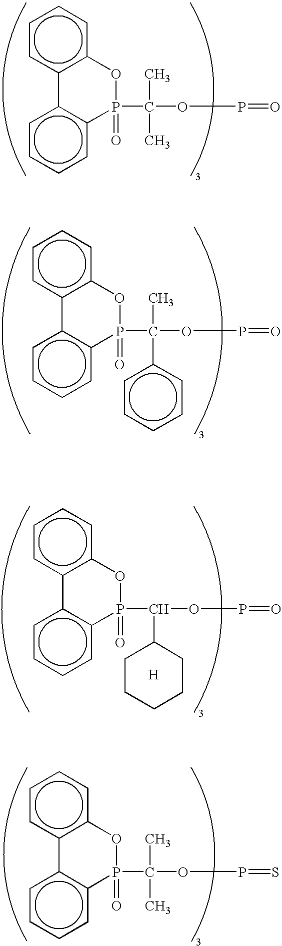
compounds represented by general formula (8), diphenyl(cyclohexylamido)phosphate, diphenyl(diethylamido)phosphate, diphenyl(morphorido)phosphate, diphenyl(octylamido)phosphate, diphenyl(benzylamido)phosphate, diphenyl(allylamido)phosphate, diphenyl(anilido)phosphate, (dimorphorido)phenyl phosphate etc.; and,
compounds represented by general formula (9), 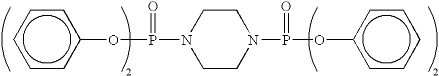
etc.

An amount of the component (B) to be used is preferably 2 to 20 parts by weight to the component (A) 100 parts by weight, more preferably 3 to 18 parts by weight, and still more preferably 4 to 16 parts by weight. An amount to be used smaller than 2 parts by weight deteriorates fire-resistant effect, and an amount exceeding 20 parts by weight impairs mechanical property, heat resistance, melt-drip-proof property, and devitrification resistance.

In the flame retardant polyester fiber for artificial hair of the present invention, organic fine particles (C) and/or inorganic fine particles (D) may be blended to form fine projections on a surface of the fiber, allowing adjustment of gloss and luster of the surface of the fiber. Combined use of the component (C) and/or (D) with the organic cyclic phosphorus compounds and/or phosphoric ester amido compounds (B) used in the present invention enables the obtained fiber to demonstrate more natural gloss and more natural luster as compared with cases using other phosphorus based flame retardant agents.

As the component (C), organic resin components without compatibility or having partial compatibility with respect to the component (A) and/or component (B) as a principal component may be used, and there may be used, for example, polyarylates, polyamides, fluororesins, silicone resins, cross linked acrylic resins, cross linked polystyrenes, etc. These may be used independently and two or more kinds may be used in combination.

As a component (D), components having a refractive index close to a refractive index of the component (A) and/or (B) are preferable, from a viewpoint of effect on transparency, and color vividness of fiber, and for example, calcium carbonate, silicon oxide, titanium oxide, aluminum oxide, zinc oxide, talc, kaolin, montmorillonite, bentonite, mica, etc. may be mentioned.

A flame retardant polyester composition used for the present invention may be manufactured, for example, in such a manner that the component (A) and the component (B), and, if needed, the component (C) or the component (D) are dry-blended beforehand, and an obtained blended material is subsequently melt-kneaded using various common mixing devices. Examples of the mixing devices include, for example, a single screw extruder, a double screw extruder, rolls, a Banbury mixer, a kneader, etc. From a viewpoint of adjustment of a degree of kneading, and simpler operation, a double screw extruder is preferable among them.

The flame retardant polyester fiber for artificial hair of the present invention may be manufactured by melt-spinning of the flame retardant polyester composition, using usual melt-spinning methods.

That is, an extruded yarn may be obtained in such a manner that melt-spinning is performed under conditions of temperatures of an extruder, a gear pump, spinneret, etc. as 270 to 310 degrees C., and subsequently the obtained extruded yarn is cooled at temperatures not more than a glass transition temperature, after passing the extruded yarn through a heated tube, and subsequently is taken up at a take-up speed of 50 to 5000 m/minute. In addition, the extruded yarn may also be cooled in a water tank for cooling to control of a size of a fiber. A temperature and a length of heated tube, a temperature and an amount of cooling gas, a temperature of cooling water tank, cooling time, and a taking up velocity may be appropriately adjusted based on an extruded amount, and a number of holes of a spinneret.

The obtained un-drawn yarn is stretched by heating. Stretching may be performed by any methods of a two-step method of stretching being performed after taking up of the un-drawn yarn, and a direct spinning and stretching method of stretching being performed without taking up. Hot stretching is performed by one-stage stretching method or two or more stages of multistage stretching method. As heating means in hot stretching, heating rollers, heat plates, steam jet devices, warm water bath, etc. may be used, and they may also be used in combination.

Various additives, such as flame retardant agents other than the component (B), heat-resistant agents, light stabilizers, fluorescence agents, antioxidants, antistatic agents, pigments, plasticizers, and lubricants, may be added into the flame retardant polyester fiber for artificial hair of the present invention, if necessary. Spun dyed fibers may be obtained by adding pigments.

Thus obtained flame retardant polyester fiber for artificial hair of the present invention is non-crimped fiber, and the size of the fiber is usually 30 to 80 dtex for artificial hair, and preferably 35 to 75 dtex. In addition, as a fiber for artificial hair, the fiber preferably has heat-resistance for a cosmetics heat instrument (hair iron) used at temperatures of 160 to 200 degrees C., anti-flammability, and self-extinguishing property.

When the flame retardant polyester fiber of the present invention is spun dyed, it can be used untreated, and when the fiber is not spun-dyed, the fiber may be dyed on same conditions for usual flame retardant polyester fibers.

As pigments, dyestuffs, auxiliary agents, etc. to be used for dyeing, materials having excellent weather resistance and flame resistance are preferably used.

The flame retardant polyester fiber for artificial hair of the present invention has outstanding curl setting properties by a cosmetics heat instrument (hair iron), and also has excellent curl retentive properties. In addition, unevenness of the surface of the fiber may give moderate matting effect, and thus the fiber may be used as artificial hair. Furthermore, use of oils, such as fiber surface treating agents and softening agents, gives improved feeling and touch to the fiber, and thereby the fiber may be more close to human hair.

In addition, the flame retardant polyester fiber for artificial hair of the present invention may be used together with other artificial hair materials, such as modacrylic fibers, polyvinyl chloride fibers, and nylon fibers, and also may be used in combination with human hair.

Since human hairs used for hair products, such as wigs, hair wigs, and false hairs is usually given removing treatment for cuticles, decolorized and dyed, and silicone based fiber surface treating agents and softening agents are used in order to secure feeling and combing property, these human hairs are flammable unlike untreated human hairs. Blending of the flame retardant polyester fiber for artificial hair of the present invention and human hair by not more than 60% of human hair content may exhibit excellent flame resistance.

### EXAMPLE

The present invention will, hereinafter, be described in still more details, referring to Examples, but the present invention is not limited to these Examples.

Measurement of physical property values was performed according to following methods.

(Strength and Elongation)

A filament was measured for a tensile elongation and strength using INTESCO Model 201 type made by INTESCO, Ltd. One filament with a length of 40 mm was sampled, both ends of the filament was sandwiched by 10 mm with cardboard (thin paper) with which double-stick tape having adhesives thereon was attached, and after air dried overnight, and a sample with a length of 20 mm was prepared. The obtained sample was clamped with a testing machine, examination was performed under conditions of temperature of 24 degrees C., not more than 80% of humidity, load 1/30 gf×size of a fiber (denier), and a speed of testing/minute of 20 mm, and tensile elongation and strength was determined. Examination was repeated 10 times on same conditions, and obtained average value was defined as a tensile elongation and strength of the filament.

(Flame Resistance)

A filament having a size of a fiber of approximately 50 dtex is cut by a length of 150 mm. The filament 0.7 g was bundled, clamped at one end by a jaw, and was hung down perpendicularly in a state fixed to a stand. A flame having a length of 20 mm was contacted on the fixed filament having 120 mm of effective length for 3 seconds, and the filament was made to burn. Flammability evaluation was given as follows: Residual flame time 0 second (not burn) as Very good, less than 3 seconds as Good,

3 seconds to 10 seconds as Fair, and

not less than 10 seconds as Bad.

Evaluation of melt-drip-proof property was given as follows: number of drips until extinguished 0 as Very good, not more than 5 as Good,

6 to 10 as Fair, and

not less than 11 as Bad.

(Gloss)

A tow filament with length of 30 cm and gross size of 100,000 dtex were evaluated under sunlight by visual inspection.

Very good: gloss adjusted to a level similar to human hair

Good: gloss adjusted moderately

Fair: a little excessive or a little insufficient gloss

Bad: excessive gloss, or insufficient gloss

(Transparency)

A tow filament with length of 30 cm and gross size of 100,000 dtex were evaluated under sunlight by visual inspection.

Good: having depth of color (vividness) and transparence

Fair: a little opacity (haze)

Bad: having opacity and no depth of color.

(Devitrification Resistance)

A tow filament with length of 10 cm and gross size of 100,000 dtex were subjected to steaming treatment (at 120 degrees C. and 100% of relative humidity 1 hour), and then was fully dried at room temperature. Variations of gloss and hue before and after steam processing were compared for evaluation by visual inspection. Larger variations before and after steam processing meant worse devitrification resistance.

Very good: gloss and hue have no variation.

Good: no gloss variation and a little variation

Fair: some variations in gloss and hue

Bad: clear variation in gloss and hue

(Curl Setting Property)

Filaments in a weft hair were wound around a pipe of 32 mm φ, and curl set by steam was given under conditions for 120 degree C., 100% of relative humidity, and 60 minutes. After aging for 60 minutes at room temperature, an end of the curled weft hair was fixed to be hung down for evaluation of curling state by visual inspection. This was defined as an index of curl retentive property. A state with a smaller length and with curl in sufficient form is preferable.

Good: curl in sufficient form

Fair: curl relaxed a little

Bad: curl loosened and form collapsed

(Iron Set Property)

This is an index of easiness of curl-setting and of retentivity of curl shape by a hair iron. Filaments were preheated by being lightly sandwiched and rubbed by a hair iron heated at 180 degrees C. three times. Adhesion and combing among the filaments, and frizz and breakage of the filaments were visually evaluated at this time. Next, the preheated filament was wound around a hair iron and held for 10 seconds, and then the hair iron was withdrawn. Easiness of withdrawing (rod out property) at this time and retentivity of curl were evaluated by visual inspection.

### Examples 1 to 16

A polyester pellet PESM6100 BLACK for coloring (manufactured by Dainichiseika Colour & Chemicals Mfg. Co., Ltd., 30% of carbon black contents: polyester content is included in the component (A) as polyester) 2 parts by weight was added to compositions having ratios shown in Table 1 comprising: a polyethylene terephthalate dried so as to have moisture content of not more than 100 ppm, phosphorus containing flame retardant agents, organic fine particles, and inorganic fine particles, and dry-blended. The obtained mixtures were delivered to a twin screw extruder, and were melt-kneaded at 280 degrees C. to be pelltized. And subsequently the pellets obtained were dried to not more than 100 ppm of moisture content. Subsequently, molten polymers were extruded from a spinneret having circle section holes of 0.5 mm of diameters of spinneret, using a melt spinning machine at 280 degrees C. The obtained filaments were cooled in a water bath with a water temperature of 50 degrees C. installed in a position of 30 mm under the spinneret, and taken up at a rate of 100 m/minute to obtain un-drawn yarns. The obtained un-drawn yarns were drawn in a warm water bath at 80 degrees C to provide four times drawn yarns. The drawn yarns were taken up using a heat roll heated at 200 degrees C., and at a rate of 100 m/minute to be heat-treated. Polyester fibers (multifilament) having a single fiber fineness of about 50 dtex were obtained.

TABLE 1

| | EXAMPLE | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Polyethylene terephthalate*¹ | 100 | 100 | 100 | 100 | 100 | 100 | 100 | 100 | 100 | 100 | 100 | 100 |
| Phosphorus containing flame | 4 | 8 | 8 | 8 | | | | | | | | |
| retardant agent (1)*² | | | | | | | | | | | | |
| Phosphorus containing flame | | | | | 6 | 10 | | | | | | |
| retardant agent (2)*³ | | | | | | | | | | | | |
| Phosphorus containing flame | | | | | | | 4 | 8 | | | | |
| retardant agent (3)*⁴ | | | | | | | | | | | | |
| Phosphorus containing flame | | | | | | | | | 6 | | | |
| retardant agent (4)*⁵ | | | | | | | | | | | | |
| Phosphorus containing flame | | | | | | | | | | 10 | | |
| retardant agent (5)*⁶ | | | | | | | | | | | | |
| Phosphorus containing flame | | | | | | | | | | | 8 | |
| retardant agent (6)*⁷ | | | | | | | | | | | | |
| Phosphorus containing flame | | | | | | | | | | | | 6 |
| retardant agent (7)*⁸ | | | | | | | | | | | | |
| Polyarylate*⁹ | | | 1 | 0.4 | | | | | | 0.8 | | |
| Talc*¹⁰ | 1 | 0.8 | | 0.8 | 0.8 | 0.6 | 1 | 0.8 | 1 | | 0.8 | 1.0 |
| Silica*¹¹ | 1 | 0.8 | | | 0.8 | 0.6 | 1 | 0.8 | 1 | | 0.8 | 1.0 |

*¹BELLPET EFG-85A, manufactured by Kanebo Gohsen, Ltd.
*²

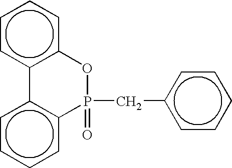

*³

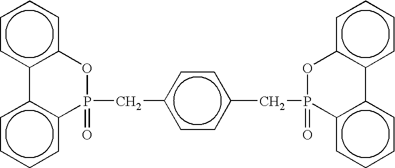

*⁴

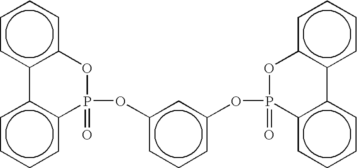

*⁵

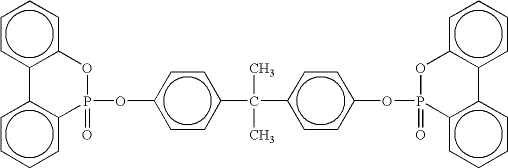

*⁶

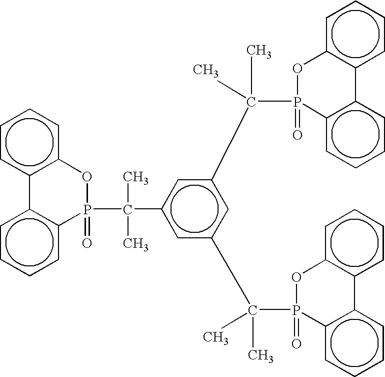

*⁷

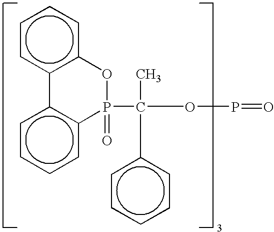

*⁸

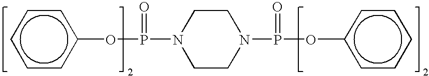

*⁹U-polymer U-100, manufactured by Unitika, Ltd.
*¹⁰PKP-53, manufactured by Fuji Talc
*¹¹IMSIL A-8, manufactured by UNIMIN CORPORATION

The obtained fibers were evaluated for tensile elongation and strength, flame resistance, gloss, transparency, devitrification resistance, cold setting property, curl holding power, and iron set property. Table 2 and Table 3 show results.

TABLE 2

| | | EXAMPLE | | | | | | | | | |
|---|---|---|---|---|---|---|---|---|---|---|---|
| | | 1 | 2 | 3 | 4 | 5 | 6 | 7 | 8 | 9 | 10 |
| Size of a fiber (dtex) | | 52 | 51 | 50 | 52 | 52 | 50 | 53 | 50 | 52 | 52 |
| Strength (cN/dtex) | | 2.9 | 2.7 | 2.7 | 2.7 | 2.7 | 2.6 | 2.4 | 2.3 | 2.3 | 2.2 |
| Elongation (%) | | 48 | 45 | 45 | 45 | 47 | 46 | 41 | 40 | 48 | 48 |
| Flame | Combustibility | Good | Very | Very | Very | Good | Very | Good | Very | Good | Very |
| resistance | | | good | good | good | | good | | good | | good |
| | Melt-drip-proof | Good | Very | Very | Very | Very | Very | Good | Good | Good | Good |
| | | | good | good | good | good | good | | | | |
| Gloss | | Good | Good | Good | Good | Good | Good | Good | Good | Good | Good |
| Transparency | | Good | Good | Good | Good | Good | Good | Good | Good | Good | Good |
| Devitrification resistance | | Good | Good | Good | Good | Good | Good | Good | Good | Good | Good |
| Curl setting | | Good | Good | Good | Good | Good | Good | Good | Good | Good | Good |
| Iron set | Adhesion | Good | Good | Good | Good | Good | Good | Good | Good | Good | Good |
| property | Frizz/Breakage | Good | Good | Good | Good | Good | Good | Good | Good | Good | Good |
| (180 | Rod out | Good | Good | Good | Good | Good | Good | Good | Good | fair | fair |
| degrees) | Setting | Good | Good | Good | Good | Good | Good | Good | Good | Good | Good |

TABLE 3

| | | EXAMPLE | | Comparative Example | | |
|---|---|---|---|---|---|---|
| | | 11 | 12 | 1 | 2 | 3 |
| Size of a fiber (dtex) | | 53 | 50 | 48 | 50 | 49 |
| Strength (cN/dtex) | | 2.6 | 2.3 | 2.0 | 2.0 | 2.5 |
| Elongation (%) | | 42 | 46 | 63 | 58 | 46 |
| Flame | Combusti- | Very | Good | Fair | Fair | Very |
| resistance | bility | good | | | | good |
| | Melt-drip- | Very | Good | Bad | Bad | Good |
| | proof | good | | | | |
| Gloss | | Good | Good | Fair | Fair | Bad |
| Transparency | | Good | Good | Fair | Fair | Good |
| Devitrification | | Good | Good | Fair | Fair | Fair |
| resistanc | | | | | | |
| Curl-setting | | Good | Good | Good | Good | Good |
| Iron set | Adhesion | Good | Good | Bad | Bad | Good |
| property | Frizz/ | Good | Good | Fair | Fair | Good |
| (180 | Breakage | | | | | |
| degrees) | Rod out | Good | Good | Bad | Bad | Fair |
| | Setting | Good | Good | Good | Good | Good |

### Comparative Example 1

To a polyethylene terephthalate (BELLPET EFG-85A, manufactured by Nippon UNIPET, Ltd.) dried by not more than 100 ppm of moisture contents 100 parts by weight, 1,3-phenylene bis(dixylenyl phosphate) 10 parts by weight, titanium oxide 1 part by weight, and polyester pellet for coloring PESM6100 BLACK (manufactured by Dainichiseika Colour & Chemicals Mfg. Co., Ltd., 30% of carbon black content) 2 parts by weight were added and dry-blended. Molten polymer was extruded using a spinneret having circle section spinneret hole of 0.5 mm of diameters, was cooled in a water bath with water at a temperature of 30 degrees C. installed in a position of 25 cm under the spinneret, and taken up at a rate of 100 m/minute to obtain un-drawn yarns. The obtained un-drawn yarns were drawn in a warm water bath at 80 degrees C. to obtain four times drawn yarns. The drawn yarns were taken up using a heat roll heated at 200 degrees C., and at a rate of 100 m/minute to be heat-treated. Polyester fibers (multifilament) having a single fiber fineness of about 49 dtex were obtained.

### Comparative Example 2

To a polyethylene terephthalate (BELLPET EFG-85A, manufactured by Nippon UNIPET, Ltd.) dried by not more than 100 ppm of moisture contents 100 parts by weight, added were 1,3-phenylene-bis(dixylenyl phosphate) 10 parts by weight, talc (PKP-53, product made from Fuji Talc Ind. Co., Ltd.) 0.8 parts by weight, silica (IMSIL A-8, manufactured by UNIMIN CORPORATION) 0.8 parts by weight, and polyester pellet for coloring PESM6100 BLACK (manufactured by Dainichiseika Colour & Chemicals Mfg. Co., Ltd., 30% of carbon black content) 2 parts by weight. And in a same manner as that in Comparative Example 1, a polyester fiber (multifilament) having a single fiber fineness of 50 dtex was obtained.

### Comparative Example 3

To a polyethylene terephthalate (BELLPET EFG-85A, manufactured by Nippon INIPET, Ltd.) dried by not more than 100 ppm of moisture contents 100 parts by weight, added were tris(tribromo neopentyl)phosphate (CR-900, manufactured by DAIHACHI CHEMICAL INDUSTRY CO., LTD.) 10 parts by weight, and polyester pellet for coloring PESM6100 BLACK (manufactured by Dainichiseika Colour & Chemicals Mfg. Co., Ltd., 30% of carbon black content) 2 parts by weight. And in a same manner as that in Comparative Example 1, a polyester fiber (multifilament) having a single fiber fineness of 48 dtex was obtained.

To a polyethylene terephthalate (BELLPET EFG-85A, manufactured by Nippon INIPET, Ltd.) dried by not more than 100 ppm of moisture contents 100 parts by weight, added were tris(tribromo neopentyl)phosphate (CR-900, manufactured by DAIHACHI CHEMICAL INDUSTRY CO., LTD.) 10 parts by weight, and polyester pellet for coloring PESM6100 BLACK (manufactured by Dainichiseika Colour & Chemicals Mfg. Co., Ltd., 30% of carbon black content) 2 parts by weight. And in a same manner as that in Comparative Example 1, a polyester fiber (multifilament) having a single fiber fineness of 48 dtex was obtained. The obtained fibers were evaluated for tensile elongation and strength, flame resistance, gloss, transparency, devitrification resistance, cold setting property, curl holding power, and iron set property. Table 3 shows results.

### INDUSTRIAL APPLICABILITY

According to the present invention, there may be obtained a polyester fiber having outstanding flame resistance, curl-setting property, melt-dripproof property, transparency, devitrification resistance, and controlled gloss of fiber, while maintaining physical properties of usual polyester fibers, such as heat-resistance and tensile elongation and strength, and may also be obtained artificial hair using the polyester fiber.

1. A flame retardant polyester fiber for artificial hair made of a composition obtained by melt kneading: 100 parts by weight of a polyester (A) comprising one or more kinds selected from polyalkylene terephthalates and copolymerized polyesters having a polyalkylene terephthalate as a principal component, and 2 to 20 parts by weight of an organic cyclic phosphorus compound and/or a phosphoric ester amido compound (B).

2. The flame retardant polyester fiber for artificial hair according to claim 1, wherein the component (A) is at least one kind of polymer selected from a group consisting of polyethylene terephthalate, polypropylene terephthalate, and polybutylene terephthalate.

3. The flame retardant polyester fiber for artificial hair according to any one of claims 1 and 2, wherein the component (B) is an organic cyclic phosphorus compound and/or a phosphoric ester amido compound represented by general formulas (1) to (9): 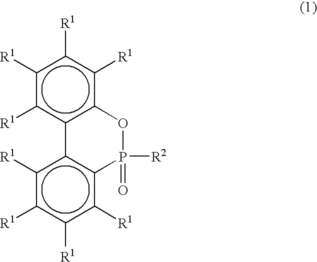
(where, R¹ represents a hydrogen atom, or a linear alkyl group, or an alkyl group having a branch, and each of the R¹ may be identical or different from each other, and R² represents a hydrogen atom, a linear alkyl group, or an alkyl group having a branch, a linear hydroxy alkyl group, or a hydroxy alkyl group having a branch, a cycloalkyl group, a substituted or non-substituted aryl group, or a substituted or non-substituted aralkyl group); 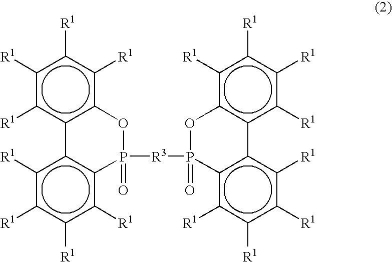
(where, R¹ represents a hydrogen atom, a linear alkyl group, or an alkyl group having a branch, and each of the R¹ may be identical or different from each other, R³ represents a divalent linear alkylene group or divalent alkylene group having branch, a linear hydroxy alkyl group, or a hydroxy alkyl group having a branch, a cycloalkylene group, an alkylene group having ether oxygen in a principal chain thereof, a substituted or non-substituted aryl group, a substituted or non-substituted aralkyl group, an α,α′-xylylene group, a substituted-α,α′-xylylene group, an α,α′-meta-xylylene group, or a substituted-α,α′-xylylene group); 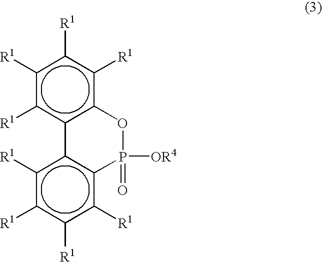
(where, R¹ represents a hydrogen atom, a linear alkyl group, or an alkyl group having a branch, and each of the R¹ may be identical or different from each other, R⁴ represents a hydrogen atom, a linear alkyl group, or an alkyl group having a branch, a cycloalkyl group, a substituted or non-substituted aryl group, or a substituted or non-substituted aralkyl group); 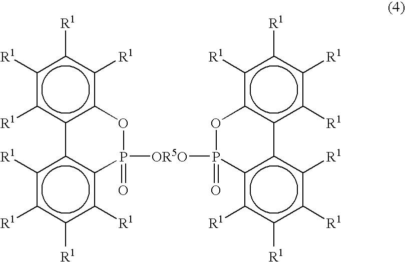
(where, R¹ represents a hydrogen atom, a linear alkyl group, or an alkyl group having a branch, and each of the R¹ may be identical or different from each other, and R⁵ represents a divalent linear alkylene group or divalent alkylene group having branch, a cycloalkylene group, an alkylene group having ether oxygen in a principal chain thereof, a substituted or non-substituted aryl group, a substituted or non-substituted aralkyl group, an α,α′-xylylene group, a substituted-α,α′-xylylene group, an α,α′-meta-xylylene group, or a substituted-α,α′-xylylene group); 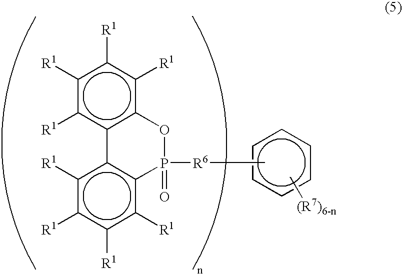
(where, R¹ represents a hydrogen atom, a linear alkyl group, or an alkyl group having a branch, and each of the R¹ may be identical or different from each other, R⁶ represents a divalent linear alkylene group or divalent alkylene group having branch, a cycloalkylene group, R⁷ represents a hydrogen atom, a linear alkyl group, or an alkyl group having a branch, each of the groups may be identical or different from each other, n represents 1 to 6); 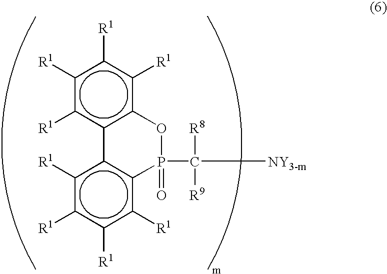
(where, R¹ represents a hydrogen atom, a linear alkyl group, or an alkyl group having a branch, and each of the R¹ may be identical or different from each other, R⁸ and R⁹ represent a hydrogen atom, a linear alkyl group, or an alkyl group having a branch, or a cycloalkyl group, Y represents a hydrogen atom, a linear alkyl group, or an alkyl group having a branch, a cycloalkyl group, a substituted or non-substituted aryl group, or a substituted or non-substituted aralkyl group, each of them may be identical or different from each other, and m represents 1 to 3); 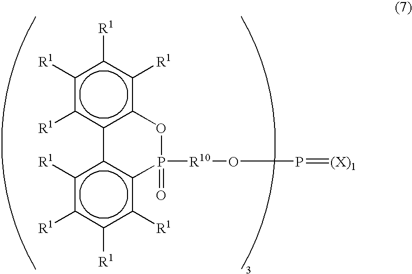
(where, R¹ represents a hydrogen atom, a linear alkyl group, or an alkyl group having a branch, and each of the R¹ may be identical or different from each other, R¹⁰ represents a divalent linear alkylene group or divalent alkylene group having branch, a linear hydroxy alkyl group, or a hydroxy alkyl group having a branch, a cycloalkylene group, an alkylene group having ether oxygen in a principal chain thereof, a substituted or non-substituted aryl group, or a substituted or non-substituted aralkyl group, X represents oxygen atom or sulfur atom, and 1 represents 0 or 1); 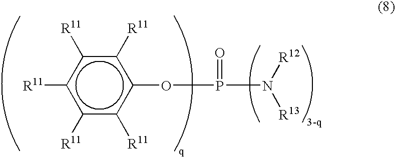
(where, R¹¹ represents a hydrogen atom, a linear alkyl group, or an alkyl group having a branch, and each of the R¹¹ may be identical or different from each other, R¹² and R¹³ represent a hydrogen atom, a linear alkyl group, or an alkyl group having a branch, a linear hydroxy alkyl group, or a hydroxy alkyl group having a branch, a cycloalkyl group, a substituted or non-substituted aryl group, or a substituted or non-substituted aralkyl group, and q represents 1 or 2); 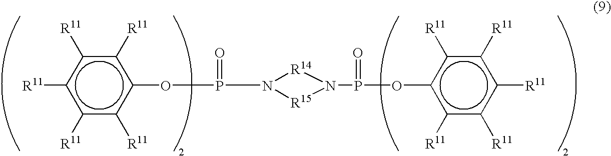
(where, R¹¹ represents a hydrogen atom a linear alkyl group, or an alkyl group having a branch, and each of the R¹¹ may be identical or different from each other, R¹⁴ and R¹⁵ represent a divalent linear alkylene group or divalent alkylene group having branch, a linear hydroxy alkyl group, or a hydroxy alkyl group having a branch, a cycloalkylene group, an alkylene group having ether oxygen in a principal chain thereof, a substituted or non-substituted aryl group, or a substituted or non-substituted aralkyl group.)

4. The flame retardant polyester fiber for artificial hair according to any one of claims 1 and 2, wherein organic fine particles (C) and/or inorganic fine particles (D) are further blended in a composition comprising component (A) and (B) to form fine projections on the surface of the fiber.

5. The flame retardant polyester fiber for artificial hair according to claim 4, wherein the component (C) is at least one kind of material selected from a group consisting of polyarylates, polyamides, fluororesins, silicone resines, cross-linked acrylic resins, and cross-linked polystyrenes.

6. The flame retardant polyester fiber for artificial hair according to claim 4, wherein the component (D) is at least one kind of material selected from a group consisting of calcium carbonate, silicon oxide, titanium oxide, aluminum oxide, zinc oxide, talc, kaolin, montmorillonite, bentonite, and mica.

7. The flame retardant polyester fiber for artificial hair according to any one of claims 1 and 2, wherein the flame retardant polyester fiber is of a form of non-crimped fiber.

8. The flame retardant polyester fiber for artificial hair according to any one of claims 1 and 2, wherein the flame retardant polyester fiber is spun-dyed.

9. The flame retardant polyester fiber for artificial hair according to any one of claims 1 and 2, wherein the flame retardant polyester fiber has a single fiber size of 5 to 100 dtex.
